(19) United States
(12) Patent Application Publication
(10) Pub. No.: US 2026/0369938 A1
(43) Pub. Date: Nov. 19, 2026

(54) CABLE CONNECTOR WITH IMPROVED CABLE ASSEMBLIES

(71) Applicant: FOXCONN INTERCONNECT TECHNOLOGY LIMITED, Grand Cayman (KY)

(72) Inventor: JON JACOBY, San Jose, CA (US)

(21) Appl. No.: 19/211,876

(22) Filed: May 19, 2025

(51) Int. Cl. H01R 13/66; H01R 12/51; H01R 12/70; H01R 12/71; H01R 13/50; H01R 13/58; H01R 13/6587

(52) U.S. Cl. CPC H01R 13/6658; H01R 12/515; H01R 12/7023; H01R 12/714; H01R 13/501; H01R 13/582; H01R 13/6587; H01R 13/6625

(57) ABSTRACT

A cable connector includes a frame defining plural mating slots and cable assemblies retained in the frame. Each cable assembly includes: a circuit board having plural conductive soldering pads, plural grounding pads, and a pair of first signal pads and a pair of second signal pads between every two adjacent grounding pads, the pairs of first signal pads being connected with corresponding pairs of second signal pads; a row of terminals including plural pairs of signal terminals and plural grounding terminals, the terminals including contacting portions and leg portions, the leg portions of each pair of signal terminals being soldered with a corresponding pair of first signal pads, the leg portions of the grounding terminals being soldered with corresponding grounding pads; and plural cables each including two core conductors soldered with a corresponding pair of second signal pads and a shielding layer electrically connected with corresponding grounding terminals.

### BACKGROUND OF THE INVENTION

### 1. Field of the Invention

The present invention relates generally to a cable connector, and more particularly to the cable connector detachably mounted upon corresponding circuit pads on a device circuit board.

### 2. Description of Related Art

US11205877B2 discloses a controlled-impedance cable assembly for removably attaching a controlled-impedance cable to a surface of a device. Signal contacts are attached to signal conductors of cables and ground members are coupled to shields of the cables. Ends of the signal conductors and of elongated appendages extending from the ground members are positioned to make a pressure contact to pads and ground lands on the surface. Pressure to make those contacts may come from deflection of the ends of the signal conductors and elongated ground appendages or from a spring. The signal contacts and elongated appendages may be positioned to provide an impedance matching an impedance with the cables.

US10856432B1 discloses a communication system including a circuit board having circuit board signal and ground contacts on an upper surface thereof. The communication system includes a cable assembly having a housing holding a cable module with cables. A ground shield and signal contacts are electrically connected to the cables. The ground shield includes ground beams with ground mating interfaces coupled to corresponding circuit board ground contacts. Each signal contact has a terminating pad terminated to the cable conductor and a signal beam with a signal mating interface coupled to the circuit board signal contact. The housing includes contact channels receiving the signal and ground beams with the mating interfaces exposed for interfacing with the circuit board.

Therefore, an improved cable connector is desired to overcome the disadvantages of the related art.

### SUMMARY OF THE INVENTION

An object of the invention is to provide a cable connector having improved cable assemblies.

To achieve the above-mentioned object, a cable connector comprises: a frame defining plural mating slots arranged in a first direction; and a plurality of cable assemblies retained in the frame, each of the cable assemblies comprising: a circuit board having a plurality of conductive soldering pad on a first surface thereof, the plurality of conductive soldering pads comprising grounding pads, and a pair of first signal pads and a pair of second signal pads between every two adjacent grounding pads, the pairs of first signal pads being connected with corresponding pairs of second signal pad; a row of terminals arranged in a second direction perpendicular to the first direction and comprising plural pairs of signal terminals transmitting differential signal and plural grounding terminals, the terminals comprising contacting portions and leg portions, the contacting portions being exposed to a corresponding mating slot, the leg portions of each pair of signal terminals being soldered with a corresponding pair of first signal pads, the leg portions of the grounding terminals being soldered with corresponding grounding pads; and a plurality of cables each comprising two core conductors and a shielding layer surrounding the two core conductors, the core conductors of each cable being soldered with a corresponding pair of second signal pads, the shielding layer of the cable being electrically connected with corresponding grounding terminals.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective view of a cable connector mounted on a device circuit board according to this present invention;

FIG. 2 is an exploded perspective view of FIG. 1;

FIG. 3 is a bottom perspective view of the cable connector in FIG. 1;

FIG. 4 is a bottom plane view of the cable connector in FIG. 3;

FIG. 5 is a cross-sectional view of the cable connector in FIG. 4 taken alone line A-A;

FIG. 6 is an exploded perspective view of the cable connector in FIG. 3;

FIG. 7 is a perspective view of a cable assembly in FIG. 6;

FIG. 8 is another perspective view of a cable assembly in FIG. 7;

FIG. 9 is an exploded perspective view of a cable assembly in FIG. 8;

FIG. 10 is a perspective view of the cable assembly before assembling, wherein the terminals, the circuit board and the cables are separated from each other;

FIG. 11 is another perspective view of FIG. 10;

FIG. 12 is a perspective view of FIG. 10, wherein the signal terminals are mounted on the circuit board;

FIG. 13 is a perspective view of FIG. 12, wherein the grounding terminals are mounted on the circuit board;

FIG. 14 is a perspective view of the cable assembly, wherein the cables are mounted on the circuit boards in FIG. 13;

FIG. 15 is a perspective view of the cable assembly, wherein the second shielding member is mounted on the circuit board in FIG. 14; and

FIG. 16 is a perspective view of a circuit board of a varied embodiment.

### DETAILED DESCRIPTION OF THE PREFERRED EMBODIMENT

Reference will now be made in detail to a preferred embodiment of the present invention.

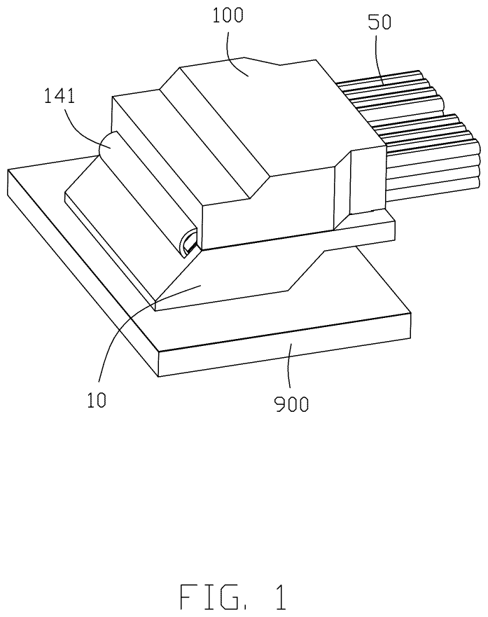

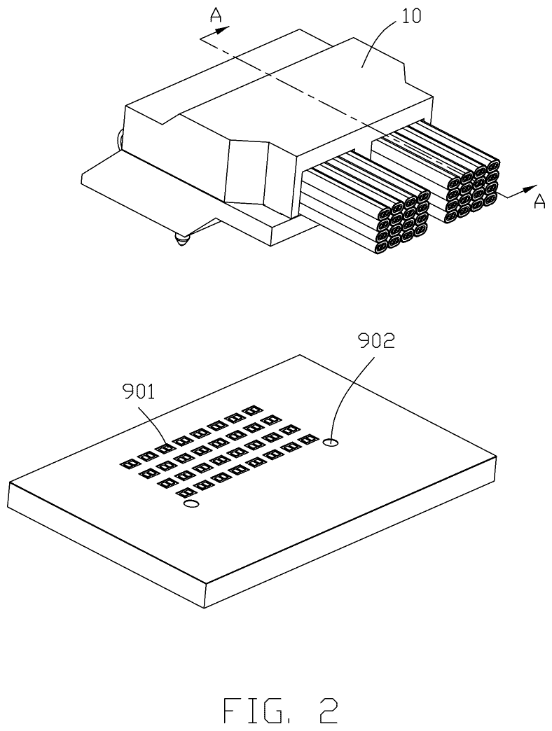

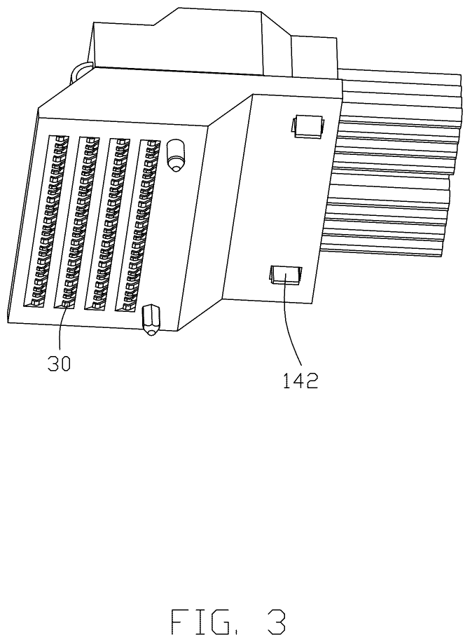

Referring to FIGS. 1-3 illustrating a cable connector 100 of an embodiment of this invention, the cable connector 100 is configured to detachably attached to a device circuit board 900 which maybe a main printed circuit board or a chip substrate in a chip package. The device circuit board 900 has a plurality of conductive pad 901 in a matric pattern on a surface thereof. The cable connector 100 is attached to the conductive pads 901 as to establish an electric connection.

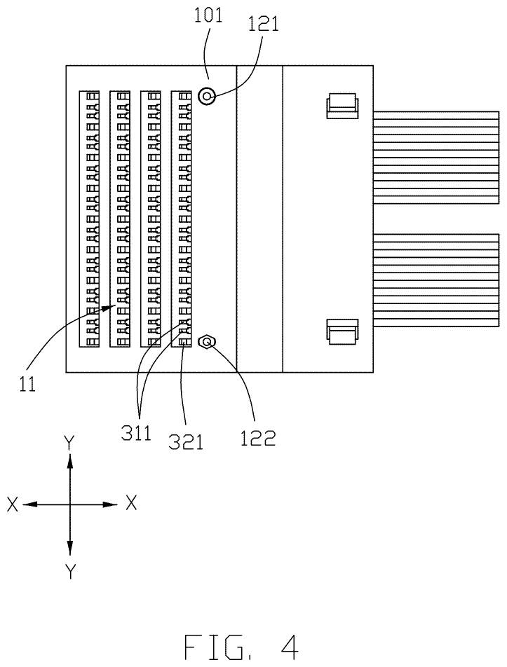

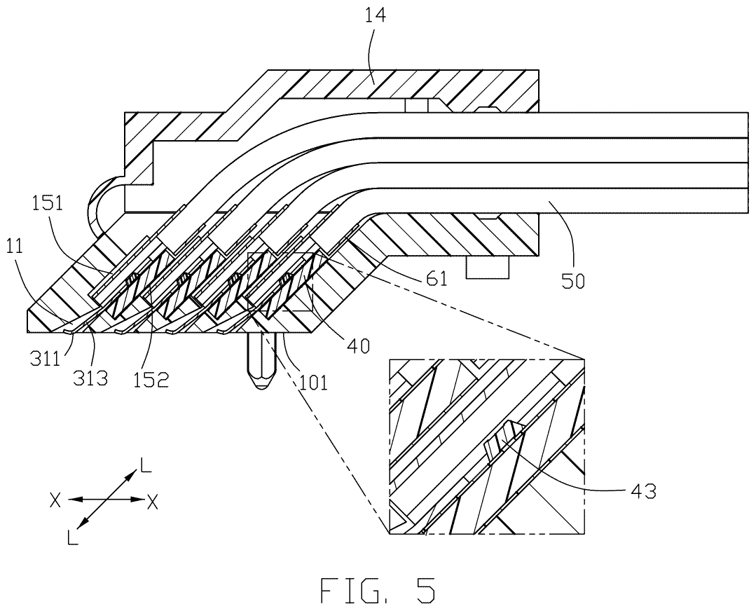

Referring to FIGS. 1-6, the cable connector 100 includes a frame 10 made from insulating material and having plural mating slots 11 arranged in a first direction X-X, and a plurality of cable assemblies 20A retained in the frame 10, each mating slot 11 extends in a second direction Y-Y. In this embodiment, four cable assemblies 20 are retained in the frame 10, and each of the cable assemblies 20 has a row of contacting portions 311, 321, the row of contacting portions 311, 321 exposes upon corresponding mating slot 11, the contacting portions are in a form of elastic beam 313 as shown in FIG. 5, the contacting portion are defined on a free end of the elastic beam 313. The frame 10 has a mating face or a lower surface 101 configured to confronting with the device circuit board 900, the mating slots 11 open through the lower surface 101. Therefore, the contacting portions 311, 321 expose upon the lower face 101 to electrically contact with the conductive pads 901 of device circuit board 900. Two distinct guiding posts 121, 122 of different shape are defined on the lower surface 101, which are matched with two guiding holes 902 defined on the device circuit board 900.

The frame 10 includes a base 13 and a cover 14. Before the cable assemblies 20 are inserted into the frame 10, the base 13 opens upwards and the cover 14 is connected with the base 13 by a hinge 141. That is, the frame 10 is of a single piece. After the cable assembles 20 are assembled into the base 13, the cover 14 is rotated toward the base 13 and coupled with the base 13. A pair of snapping portions 142 on the cover 14 is inserted into and locked with the snapping holes defined on the base 13. The hinge and the snapping features are used to capture the cables and provide strain relief, so as to reduce the size of the frame 10. The base 13 includes two oblique walls 131 and two upright walls 132, so that the cable assemblies 20 are disposed in the base 13 in an oblique manner. As shown in FIG. 5, the frame 10 defines four receiving passages 151 by partitioning walls 152 in an inside thereof, the mating slots 11 communicates with corresponding receiving passages 151. Therefore, the cable assemblies 20 are inserted in corresponding receiving passages 151.

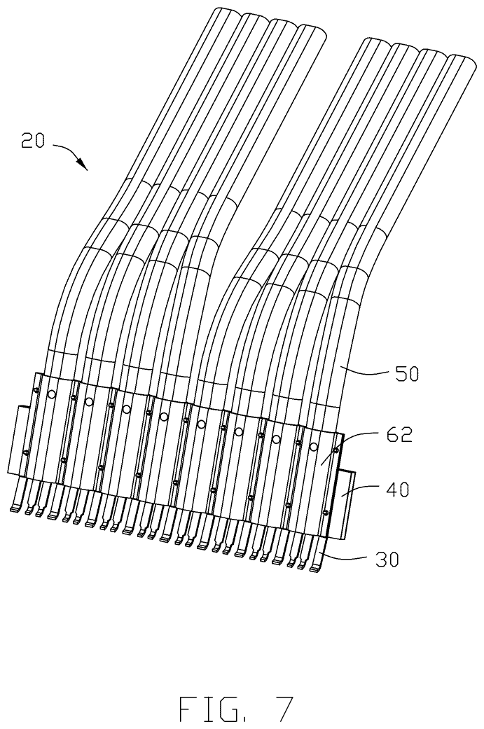

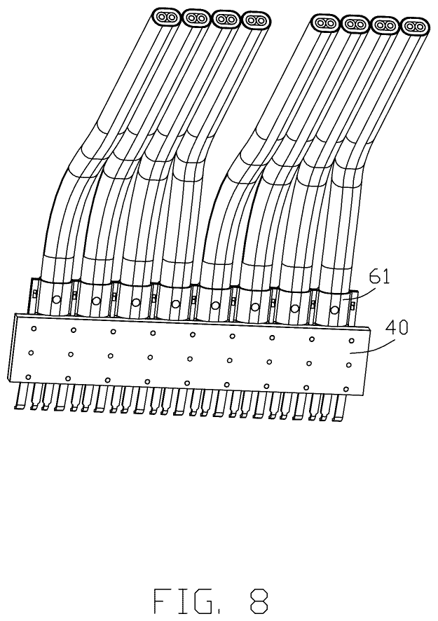

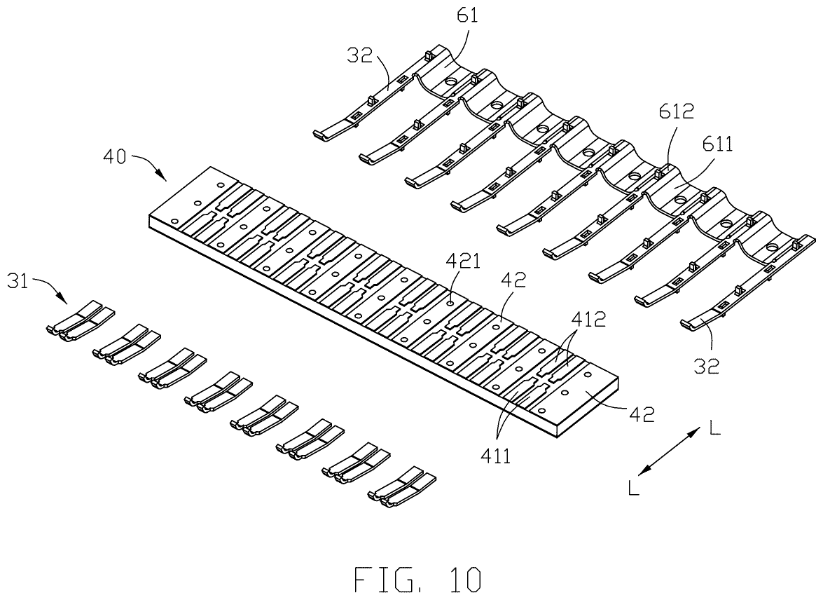

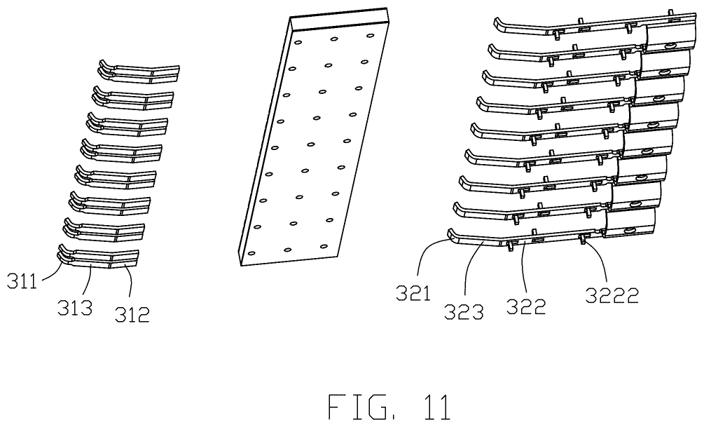

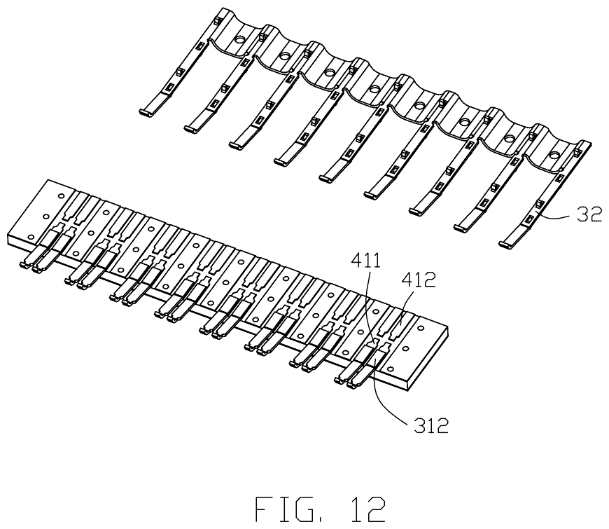

Referring to FIGS. 7-15, each of the cable assemblies 20 includes a row of terminals 30, a circuit board 40, and a plurality of cables 50. Combined with FIGS. 10-11, the circuit board 40 has a plurality of conductive soldering pads on a first or front surface thereof. The plurality of conductive soldering pads include grounding pads 42, and a pair of first signal pads 411 and a pair of second signal pads 412 between every two adjacent grounding pads 42. The pairs of first signal pads 411 are connected with corresponding pairs of second signal pads 412 one by one to make electrically connections. In this embodiment, the first signal pads 411 and the second signal pads 412 are mechanically connected with isolation capacitors 43 on the first surface of the circuit board to make electrical connections therebetween. The isolation capacitors 43 are soldered with two proximate ends of the first and second signal pads. The grounding pad is of a long ground soldering pads. In this embodiment, the circuit board 40 is a single lay printed circuit board. Alternatively, a double-sided circuit board can also be used. The circuit board 40 defines a ground plane on a back surface thereof. The ground pads 42 on the first surface are connected to the ground plane by plated through holes.

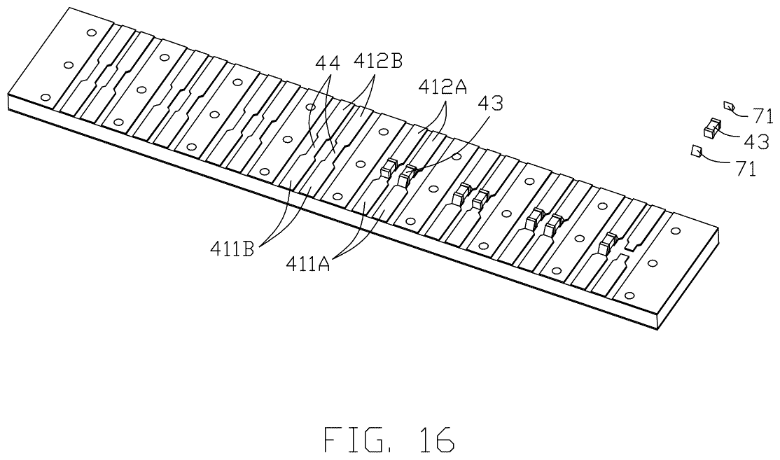

Referring to FIG. 16 showing a varied embodiment of the circuit board, some of the first signal pads 411A and the second signal pads 412A for receiving differential signal are mechanically connected with isolation capacitors 43 to make electrical connections therebetween, while some of the first sign pads 411A and the second signal pads 411B to transmit differential signal are mechanically connected with first pads 44 on the first surface of the circuit board. The isolation capacitors 43 benefit SI performance for the signal pads receiving differential signal. The soldering pads and the traces on the first surface of the circuit board are copper pads and copper traces, which are made by etching a copper plane in a conventional way in PCB industry.

Alternatively, all the first signal pads 411 are mechanically connected with corresponding second signal pads 412 by the trace 44. Alternatively, the grounding pads 42 are divided into two rows, that means, the grounding pads includes first grounding pads same to the first signal pads, and second grounding pads same to the second signal pads, the first grounding pads and the second grounding pads are mechanically connected with traces. Therefore, a first or lower soldering pads are located along a front or lower side of the circuit board, and a second or upper soldering pads are located along a rear or upper side of the circuit board. The row of the first pads and the row of the second pads are arranged in a third direction L-L in FIG. 5 and FIG. 10. The third direction L-L is angled to the first direction X-X with an acute angle.

As shown in FIGS. 10-15, the row of terminals 30 is arranged in a second direction B-B perpendicular to the first direction, which comprises plural pairs of signal terminals 31 transmitting differential signal and plural grounding terminals 32. In this embodiment, each pair of signal terminals is located between two grounding terminals 32. The terminals 30 comprise contacting portions 311, 321 and leg portions 312, 322. The contacting portions 311, 321 exposes upon corresponding mating slot 11 as shown in FIG. 5, the leg portions 312 of each pair of signal terminals 31 are soldered with corresponding pair of first signal pads 411, the leg portions 322 of the grounding terminals are soldered with corresponding grounding pads 42. The elastic beams 313, 323 directly extend from corresponding leg portions 312, 322, the contacting portion 311, 321 bends to form an arc contacting portion. The elastic beams are oblique compared with the leg portions. The leg portions are retained on the circuit board 30 while the elastic beams shift and provide an elastic press against the device circuit boards 900 after the cable connector 100 is attached to the device circuit boards 900. The contacting portion 311 becomes thinner than the elastic beam 313 of the signal terminals 31 in the second direction. The contacting portion 322 keep a same width with the elastic beam 323 of the grounding terminals 32.

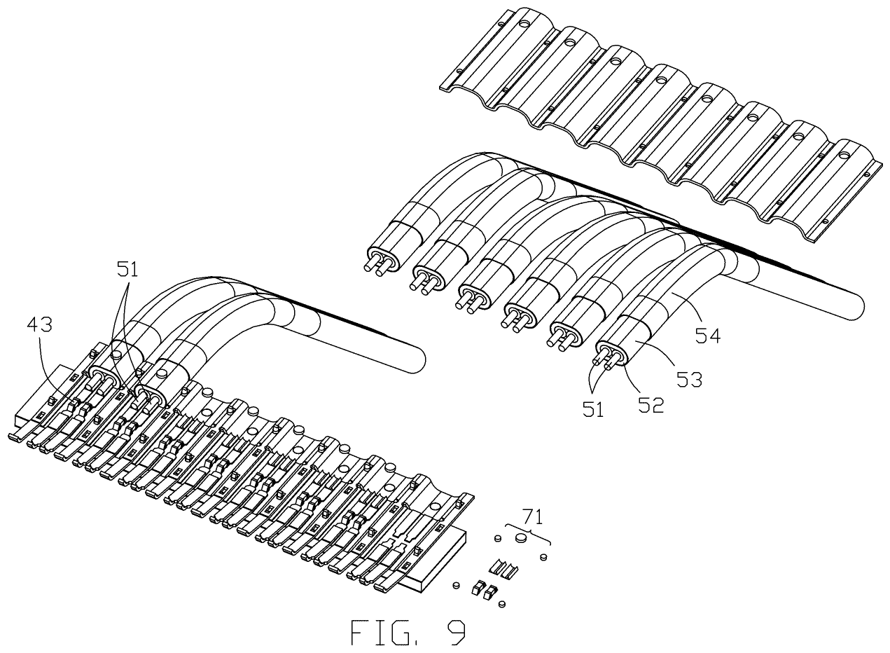

Combined with FIG. 9, each of the cables 50 includes two core conductors 51 and an insulating layer 52 surrounding the two core conductors 51 and a shielding layer 53 surrounding the two core conductors and an outer insulating layer 54 surrounding the shielding layer 53. One free end of the shielding layer 53 and the core conductors 51 expose to an exterior of the cable. The core conductors 51 of each cable are soldered with corresponding pair of second signal pads 412 and the shielding layers 53 of the cables are electrically connected with corresponding grounding terminals 32.

The differential signals are transmitted through the signal terminals 31, first and second signal pads 411, 412 of the circuit board 40 and the core conductors 51 of the cables. Grounding path is established through the grounding terminals 32, grounding pads 42 and the shielding layers 53 of the cables.

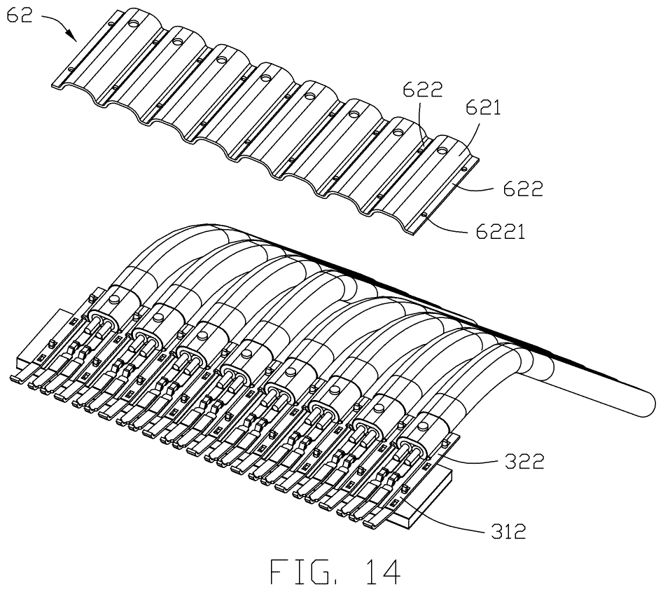

Each of the cable assembly 20 further includes a first shielding member 61. The first shielding member 61 includes plural clapping portions 611 and plural flat portions 612 each between two adjacent clapping portions 611. The clapping portions 611 partly surround corresponding shielding layers 53 of corresponding cables to establish the grounding path as clearly shown in FIG. 14. In this embodiment, the grounding terminals 32 unitarily extend from the first shielding member 61. Alternatively, the grounding terminals are separated from the first shielding member 61

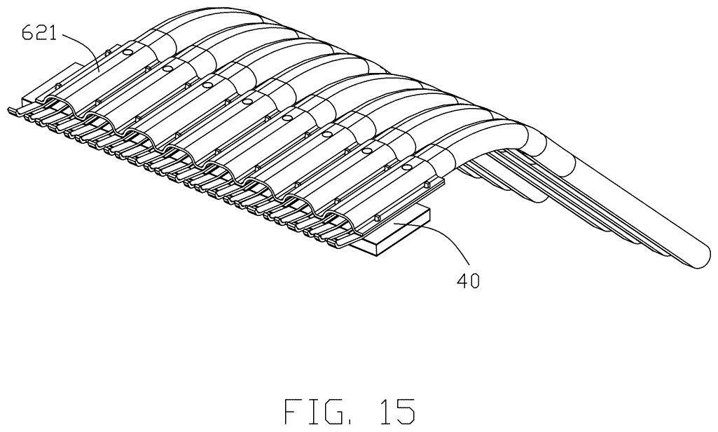

Furthermore, each of the cable assembly 20 includes a second shielding member 62 as shown in FIGS. 14-15. The second shielding member 62 includes plural clapping portions 621 and plural flat portions 622 each between every two adjacent clapping portions 621. The second clapping portions 621 partly surround the shielding layers 53 of corresponding cables. That is, one clapping portion 611 and one clapping portion 621 cooperatively surround the shielding layer 53 of the cable at the free end thereof. Moreover, the clapping portion 621 extends forwards, so that the clapping portions 621 shield the leg portions 312 of corresponding signal terminals 31. The flat portions 622 of the second shielding member 62 are directly attached to the leg portions 322 of corresponding grounding terminals 32.

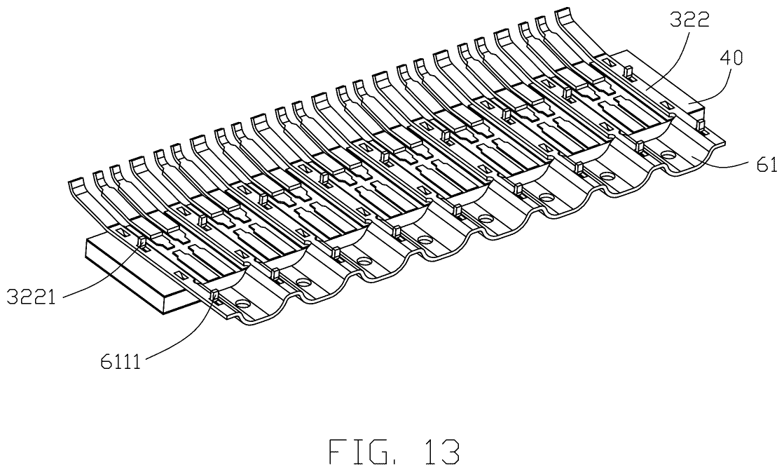

Referring to FIG. 9 and FIG. 13, the second shielding member 61 is located behind the circuit board 3. The leg portions 322 of the grounding terminals 32 extend from the flat portion 612 of the first shielding member. The leg portions 322 and the flat portions 612 have upwards tabs 3221, 6111 punched therefrom and remain openings, the upward tabs are inserted into and retained with holes 6221 defined on the flat portions 622 of the second shielding member 62 as shown in FIG. 14. Alternatively, the leg portions of the grounding terminals may be separated from the flat portions of the first shielding, the leg portions of the grounding terminals are soldered with the grounding pads, the flat portions extend beyond the first clapping portions and are soldered with the grounding terminals. As shown in FIGS. 10-11, the leg portions 322 have downward tabs 3222, the downward tabs 3222 are inserted into and retained with holes 421 defined on the grounding pas of the circuit board. Therefore, a structural attachment and a positional control are got. Solder pastes 71 are applied to the openings for further retaining. The first and the second shielding member have holes opening through the clapping portions to the shielding layer 53. Other solder pastes 71 are applied to the holes of the first and the second shielding members for further retaining.

FIGS. 10-15 substantially illustrate an assembling process of one cable assembly 20. Step 1, dispose the row of the signal terminals 31 with a carrier on the first signal pads 411 of the circuit board 40 and then solder the leg portions 312 of the signal terminals 31 to the first signal pads 411 and then break off the carrier. Step 2, dispose the first shielding member 41 behind the circuit board 30 and the grounding terminals 32 on the grounding pads 42, and then solder the leg portions 322 of the grounding terminals 32 to the grounding pads 42. Step 3, dispose the core conductors 51 of the cables on the second signal pads 412 and then solder the core conductor 51 to the second signal pads 412. Moreover, capacitors 43 may be disposed between the first signal pads 411 and corresponding second signal pads 412. Step 4, dispose the second shielding member 62 on the circuit board 30 and solder the flat portions 622 of the second shielding member to the flat portions 612 of the first shielding member 61 and the cables 50. Therefore, one complete cable assembly 20 is formed.

The four cable assemblies 20 are inserted into the receiving passages 151 one by one. After one cable assembly is inserted into the receiving passages 151 and then epoxy material is applied to glue the cables for strain relief. After all the conductive assembles 20 are assembled. The cover 14 is rotated and snapped with the base 13. The epoxy material permanently attaches the cables and the frame into a single non re-workable block. In this embodiment, the cable assemblies 20 are distinct interposers.

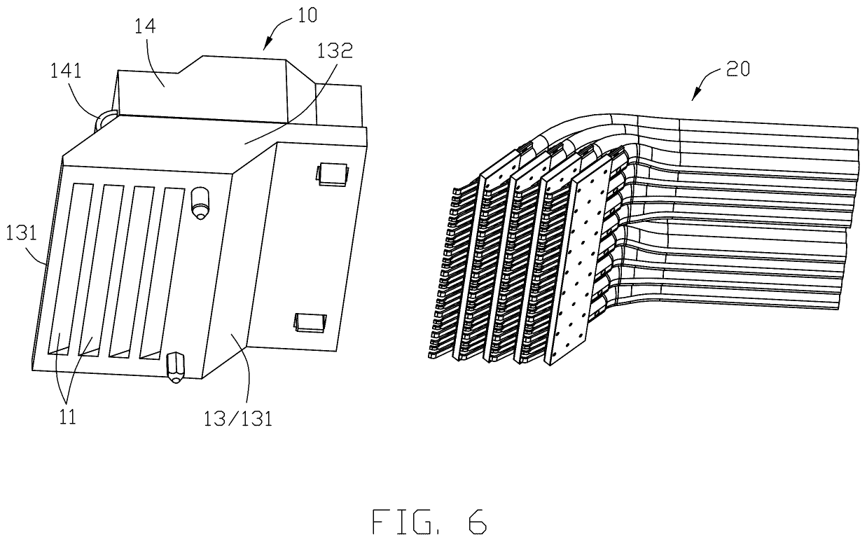

Referring to FIGS. 5-6, the circuit boards 40 are longitudinal. The cables 50 are disposed in a row in the second direction. That is, the circuit board 40 extends parallel to the row of cables. The circuit boards 40 are located in the frame 10 slantwise relative to the lower surface 101. The circuit boards 40 with the second shielding members 62 positioned in the receiving passages 151. The contacting portions 311, 312 of the terminals are located in front of the circuit board 40 and the first shield member 61 is located behind the circuit board. Alternatively, a grounding/drain wire may replace the shielding layer of the cables and the grounding/drain wires electrically contact with leg portions 322 of the grounding terminals or the grounding pads 42.

However, the disclosure is illustrative only, changes may be made in detail, especially in matter of shape, size, and arrangement of parts within the principles of the invention.

1. A cable connector comprising:
a frame defining plural mating slots arranged in a first direction; and
a plurality of cable assemblies retained in the frame, each of the cable assemblies comprising:
a circuit board having a plurality of conductive soldering pad on a first surface thereof, the plurality of conductive soldering pads comprising grounding pads, and a pair of first signal pads and a pair of second signal pads between every two adjacent grounding pads, the pairs of first signal pads being connected with corresponding pairs of second signal pad;
a row of terminals arranged in a second direction perpendicular to the first direction and comprising plural pairs of signal terminals transmitting differential signal and plural grounding terminals, the terminals comprising contacting portions and leg portions, the contacting portions being exposed to a corresponding mating slot, the leg portions of each pair of signal terminals being soldered with a corresponding pair of first signal pads, the leg portions of the grounding terminals being soldered with corresponding grounding pads; and
a plurality of cables each comprising two core conductors and a shielding layer surrounding the two core conductors, the core conductors of each cable being soldered with a corresponding pair of second signal pads, the shielding layer of the cable being electrically connected with corresponding grounding terminals.

2. The cable connector as claimed in claim 1, wherein each of the cable assemblies comprise a first shielding member comprising plural clapping portions, the clapping portions at least partly surrounding the shielding layers of corresponding cables.

3. The cable connector as claimed in claim 2, wherein each of the cable assemblies comprise a second shielding member comprising plural clapping portions, the clapping portions of the second shielding member surround the shielding layers of corresponding cables and shield the leg portions of corresponding pair of signal terminals.

4. The cable connector as claimed in claim 3, wherein the second shielding member comprises plural flat portions each between every adjacent clapping portions thereof, the flat portions of the second shielding member are attached to the leg portions of corresponding grounding terminals.

5. The cable connector as claimed in claim 4, wherein the contacting portions of the terminals are located in front of the circuit board, the first shield member is located behind the circuit board.

6. The cable connector as claimed in claim 1, wherein epoxy material is applied to the cables of each of the cable assemblies after each of the cable assemblies is assembled into the frame.

7. The cable connector as claimed in claim 1, wherein the frame has a lower surface configured to confronting with a device circuit board, the mating slots open through the lower surface.

8. The cable connector as claimed in claim 7, wherein the circuit boards are located slantwise relative to the lower surface.

9. The cable connector as claimed in claim 7, wherein the frame has plural receiving passages communicating with corresponding mating slots, the mating slots and the receiving passages are disposed in an oblique manner.

10. The cable connector as claimed in claim 9, wherein the circuit boards are positioned in corresponding passages.

11. The cable connector as claimed in claim 1, wherein the first signal pads and the second signal pads are mechanically connected with traces on the first surface of the circuit board to make electrical connections therebetween.

12. The cable connector as claimed in claim 1, wherein the first sign pads and the second signal pads are mechanically connected with isolation capacitors to make electrical connections therebetween.

13. The cable connector as claimed in claim 1, wherein the first sign pads and the second signal pads are mechanically connected with isolation capacitors to make electrical connections therebetween.

14. The cable connector as claimed in claim 1, wherein some of the first signal pads and the second signal pads for receiving differential signal are mechanically connected with isolation capacitors to make electrical connections therebetween, while some of the first sign pads and the second signal pads to transmit differential signal are mechanically connected with traces on the first surface of the circuit board.

15. A cable connector comprising at least one cable assembly, the at least one cable assembly comprising:
a circuit board having a plurality of conductive soldering pads, the plurality of soldering pads comprising a row of first soldering pads and a row of second soldering pads, the first soldering pads being electrically connected with corresponding second soldering pads respectively;
a row of terminals supported on the circuit board and comprising plural pairs of signal terminals transmitting differential signal and plural grounding terminals, the terminals comprising contacting portions and leg portions, the leg portions being soldered with corresponding first soldering pads; and
a plurality of cables each comprising two core conductors, an insulating layer surrounding the two core conductors and a shielding layer, the core conductors of each cable being attached to corresponding second soldering pads to transmit differential signal through corresponding first soldering pads and corresponding pair of signal terminals, the shielding layer being electrically connected with corresponding second soldering pads to establish a grounding path.

16. The cable connector as claimed in claim 15, wherein the row of first soldering pads comprise pairs of first signal pads and two first grounding pads located at opposite sides of each pair of first signal pads, the row of second soldering pads comprise pairs of second signal pads electrically connected with but separated from the first signal pads and two second grounding pads located at opposite sides of each pair of second signal pads, the first grounding pads and corresponding second grounding pads are united as a long ground soldering pad.

17. The cable connector as claimed in claim 16 comprising a first shielding member, wherein the first shielding member comprises plural first clapping portions and a first flat portion between every two adjacent first clapping portion, the clapping portions partly surrounding the shielding layers of corresponding cables.

18. The cable connector as claimed in claim 13, wherein the leg portions of the grounding terminals unitarily extend from corresponding first flat portions, the leg portions are soldered with the long ground soldering pads.

19. The cable connector as claimed in claim 13, comprising a second shielding member, wherein the second shielding member comprises plural second clapping portions and a second flat portion between every two adjacent second clapping portions, the second clapping portions surround the shielding layers of corresponding cables and shield the leg portions of corresponding pair of signal terminals.

20. The cable connector as claimed in claim 16, wherein the circuit board has a ground plane on a back surface thereof, the long ground soldering pads on the first surface are connected to the ground plane by plated through holes.
